(19) United States
(12) Patent Application Publication
(10) Pub. No.: US 2015/0229148 A1
(43) Pub. Date: Aug. 13, 2015

(54) Blind-Mate Power Charging Station for Portable Electronic Devices

(71) Applicant: Transistor Devices, Inc. d/b/a TDI Power, Hackettstown, NJ (US)

(72) Inventors: Tunc Icoz, Bridgewater, NJ (US); Jessica Dennis, Hackettstown, NJ (US); Manuel Lavin, Hackettstown, NJ (US); James Feely, Hackettstown, NJ (US); Gary Mulcahy, Flanders, NJ (US); John Santini, Columbia, NJ (US); Ronald Hamaoui, Hackettstown, NJ (US); Robert Scholl, Hackettstown, NJ (US); Matthew Fuhrmann, Hackettstown, NJ (US)

(21) Appl. No.: 14/618,563

(22) Filed: Feb. 10, 2015

Related U.S. Application Data
(60) Provisional application No. 61/937,758, filed on Feb. 10, 2014.

(51) Int. Cl. H02J 7/00

(52) U.S. Cl. CPC H02J 7/0042; H02J 7/0031; H02J 7/0052

(57) ABSTRACT

A blind-mate power charging station includes a receptacle, a base, and electrical circuitry. The receptacle includes a receptacle housing, an inner housing, and electrical contacts. The receptacle housing includes a pair of outer extensions, each outer extension tapering toward an outer extension tip. The inner housing is held within the receptacle housing and includes inner extensions forming parallel slots between pairs of inner extensions. Each electrical contact is held in one of the parallel slots by a pair of the inner extensions. The base receives the receptacle and mounts the receptacle to a stationary surface. The electrical circuitry couples the electrical contacts to an electricity source. The receptacle is shaped to receive a plug including a plug head and at least two prongs. Each prong engages one of the electrical contacts such that the receptacle provides electricity to the plug.

### REFERENCE TO RELATED APPLICATIONS

This application claims one or more inventions which were disclosed in Provisional Application No. 61/937,758, filed Feb. 10, 2014, entitled “Blind-Mate Power Docking Station for Portable Electronic Devices”. The benefit under 35 USC §119(e) of the United States provisional application is hereby claimed, and the aforementioned application is hereby incorporated herein by reference.

### BACKGROUND OF THE INVENTION

1. Field of the Invention

The invention pertains to charging apparatus and methods. More particularly, the invention pertains to charging stations for charging of portable electronic devices.

2. Description of Related Art

Battery operated portable electronics, such as personal computers, medical diagnostic devices, and patient monitoring devices, are extensively used as consumer products in various environments, including hospitals and medical centers. For such systems, on-board batteries require regular charging to provide uninterrupted power to the portable electronic devices. Typically, there is a battery charger installed on the system to convert AC power to DC output for on-board batteries to be charged.

Conventional charging carts require the user to manually plug the on-board, flexible AC line cord into a conventional AC outlet to charge the batteries. In other words, an operator is required to hold the AC cord line and manually insert the plug into an AC outlet in the building/facility to initiate the charging operation. Often, operators forget to perform or ignore performing this manual operation, or an outlet may not be within reach of the cord, which results in the batteries draining and the portable electronics on the cart being inoperable until the cord is finally plugged in by the same or another operator.

### SUMMARY OF THE INVENTION

A blind-mate power charging station includes a receptacle, a base, and electrical circuitry. The receptacle includes a receptacle housing, an inner housing, and electrical contacts. The receptacle housing includes a pair of outer extensions, each outer extension tapering toward an outer extension tip. The inner housing is held within the receptacle housing and includes inner extensions forming parallel slots between pairs of inner extensions. Each electrical contact is held in one of the parallel slots by a pair of the inner extensions. The base receives the receptacle and mounts the receptacle to a stationary surface. The electrical circuitry couples the electrical contacts to an electricity source. The receptacle is shaped to receive a plug including a plug head and at least two prongs. Each prong engages one of the electrical contacts such that the receptacle provides electricity to the plug.

A method of docking a portable electronic device to a blind-mate power charging station includes aligning a plug on an arm of the portable electronic device to a receptacle of the blind-mate power charging station. The method also includes moving the arm such that each of the prongs of the plug is inserted into one of the parallel slots to contact one of the electrical contacts, thereby docking the portable electronic device to the blind-mate power charging station.

### BRIEF DESCRIPTION OF THE DRAWINGS

FIG. 1 shows a perspective view of a plug mounted on an arm of a portable electronic device such as a cart plugged into a wall-mounted receptacle of a blind-mate power charging station.

FIG. 2 shows a partial cross sectional view of the plug of FIG. 1 fully engaged with the receptacle of FIG. 1.

FIG. 3 shows a perspective view corresponding to FIG. 1, in which there are multiple plugs inserted into the same receptacle for concurrent charging.

FIG. 4a shows a perspective view of the base and housing of the blind-mate power charging station.

FIG. 4b shows a perspective view of the bezel of the blind-mate power charging station of FIG. 1.

FIG. 4c shows an exploded side view of the blind-mate power charging station with the base and housing of FIG. 4a and the bezel of FIG. 4b.

FIG. 5 shows a plug on an adjustable arm.

FIG. 6 shows a cut-through side view of mated connectors in an embodiment of the present invention.

FIG. 7a shows contacts on the plug of FIG. 6 with showing vertically-stacked blade type connectors as the plug is engaging the receptacle of FIG. 6.

FIG. 7b shows the plug of FIG. 7a fully engaged with the receptacle.

FIG. 8a shows an intelligent arm in a retracted position.

FIG. 8b shows the intelligent arm of FIG. 8a in an extended position.

### DETAILED DESCRIPTION OF THE INVENTION

A wall-mounted charging station provides an easy-to-insert, blind-mate electrical connection for portable electronic devices, eliminating the need for the manual function of plugging in a cord from the portable electronic device into the charging station. A wall-mounted charging station eliminates human interaction, i.e. the step of an end user plugging the cord into an AC outlet, for the charging of on-board batteries for power systems mounted on portable platforms. The wall-mounted charging station may also incorporate hot-swappable battery charging docks to allow users the ability to charge batteries not installed on the system. The wall-mounted charging station may be used for both AC and DC power applications.

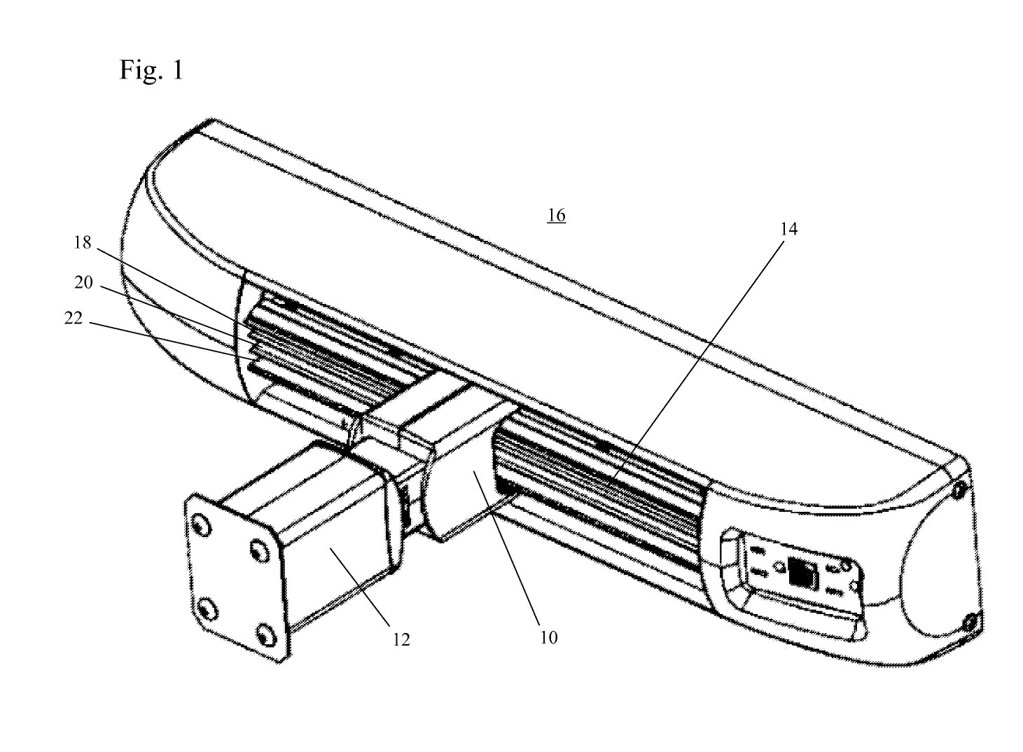

The wall-mounted charging station preferably includes a wall mounted receptacle that is hard-wired to the AC line available in the facility and a portable electronic device-mounted plug that is affixed to the portable system via adjustable brackets (see FIG. 1). Preferred features of the wall-mounted charging station include, but are not limited to:
1. Blind mate contacts that do not require human intervention, i.e. manual plugging
2. Hidden electrical contacts within the receptacle for electrical hazard protection
3. Self-centering, self-guiding contacts to prevent excessive stresses on contacts in case of misalignment
4. Provisions for Ground Fault Circuit Interrupter (GFCI) circuitry
5. Provisions for prevention of arcing during insertion and disengagement of contacts
6. Adaptability to both AC and DC power applications
7. Provisions for connector handshaking to apply and cut-off power to contacts
8. Ability to mount on any style portable systems
9. Ability to charge more than one portable system, e.g. medical cart, at the same time

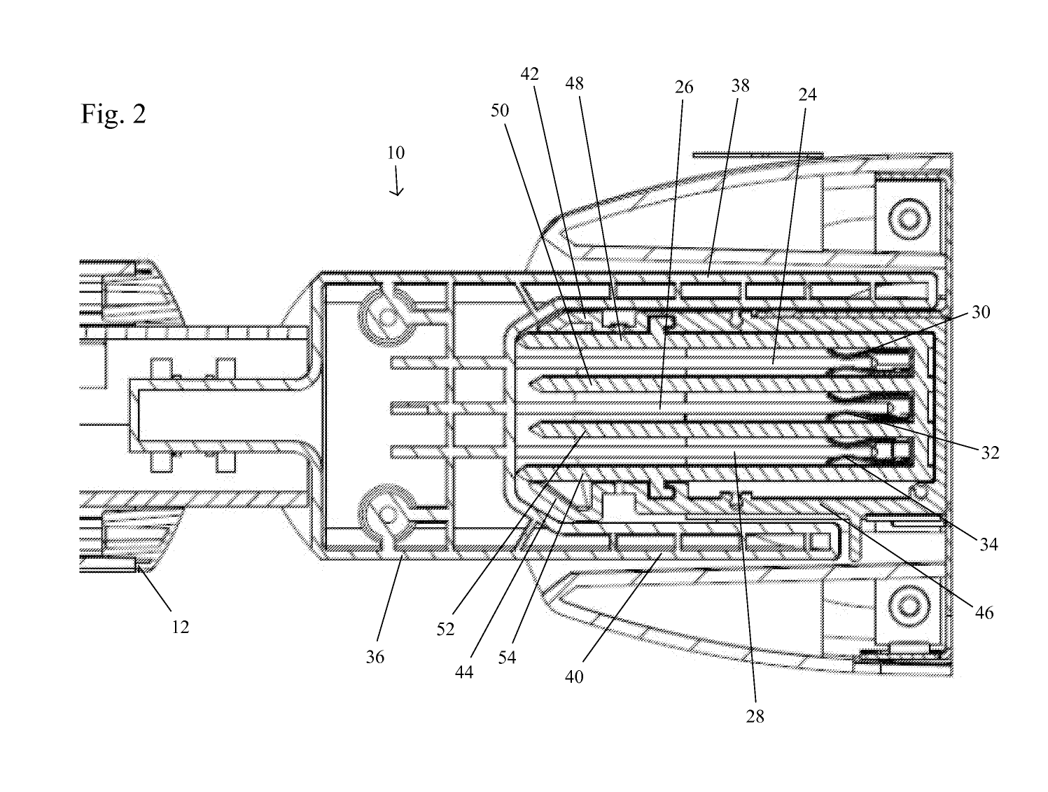

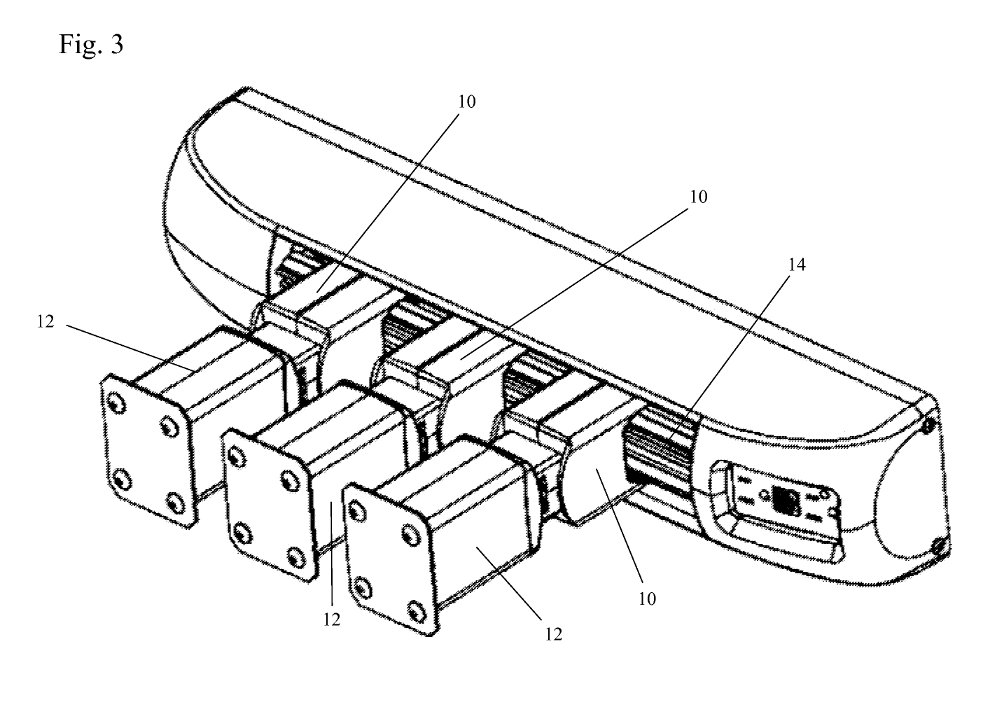

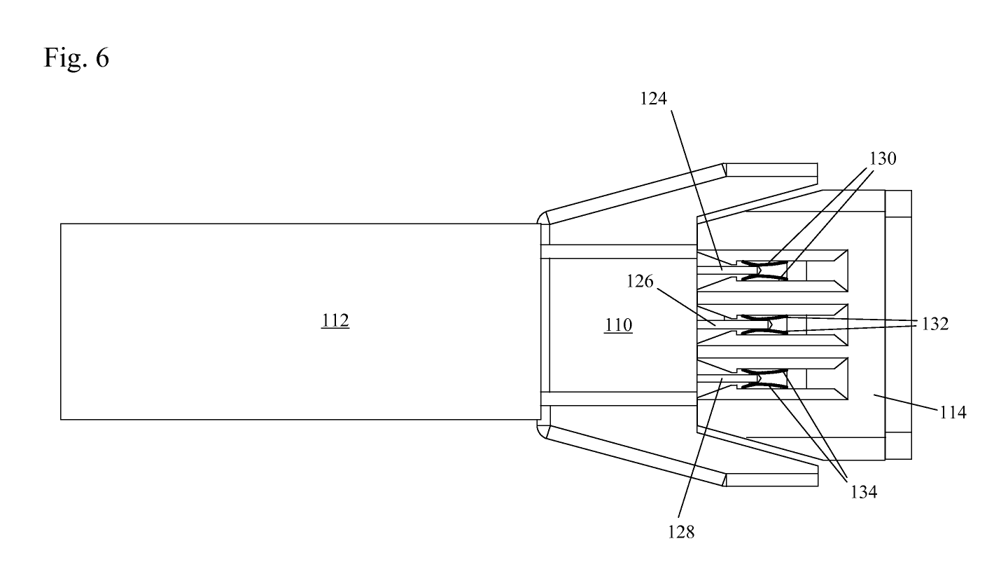

The receptacle is preferably hard wired to the main power line (AC or DC), gets mounted to the wall or a stationary substrate, and contains electrical contacts that are mounted within. The receptacle transfers electricity to the portable electronic device when mated to a plug of the portable electronic device to allow power to the battery chargers on the portable electronic device (see FIG. 2 and FIG. 6). The receptacle houses electrical contacts that are recessed within a housing and preferably have several built-in safety features. The live electrical contacts are recessed and protected from accidental reach by adequate spacing. The connector pair has a self-centering design to protect the contacts from excessive mechanical stress during insertion and disengagement. Another preferred feature of the wall-mounted docking system is that it can provide power to more than one portable system. That is, the wall receptacle is wide enough to accommodate several mating plugs, such that multiple devices may be charged simultaneously (see FIG. 3).

The wall mounted receptacle preferably has the following features:
1. Attachment capability to a wall or a stationary substrate
2. Hard-wiring capability to the main power line
3. Ground Fault Circuit Interrupter (GFCI) circuitry
4. Electrical or mechanical provisions for arc prevention
5. Guiding and self-aligning profile
6. Circuitry to de-energize the contacts unless a mating plug is inserted
7. Ability to accept multiple plugs simultaneously

In some embodiments, the receptacle is assembled with an electrically insulating connector housing that is preferably made out of plastic. The housing encloses the electrical contacts and mounts over a rigid plate against the wall or the mounting substrate. The connector housing includes surface features to self-align the connector pairs and protect the conductors from being physically damaged.

The receptacle additionally preferably includes GFCI protection which conforms to the latest industry standards as outlined by OSHA, UL, CSA, and NEC. GFCI protection is used to protect against occurrences of serious injury or death associated with electrical shock accidents in damp or wet installation locations. Arc monitoring and prevention provisions are also preferably included to prevent arcing during insertion and disengagement of the contacts.

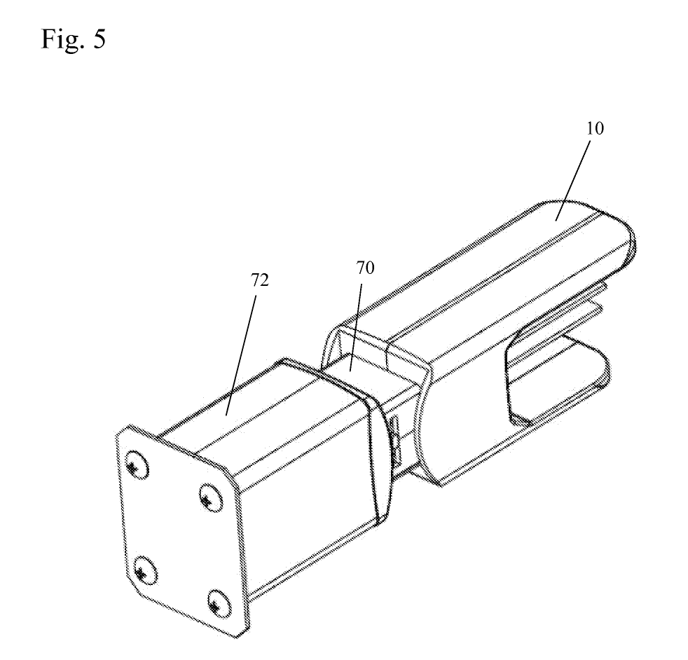

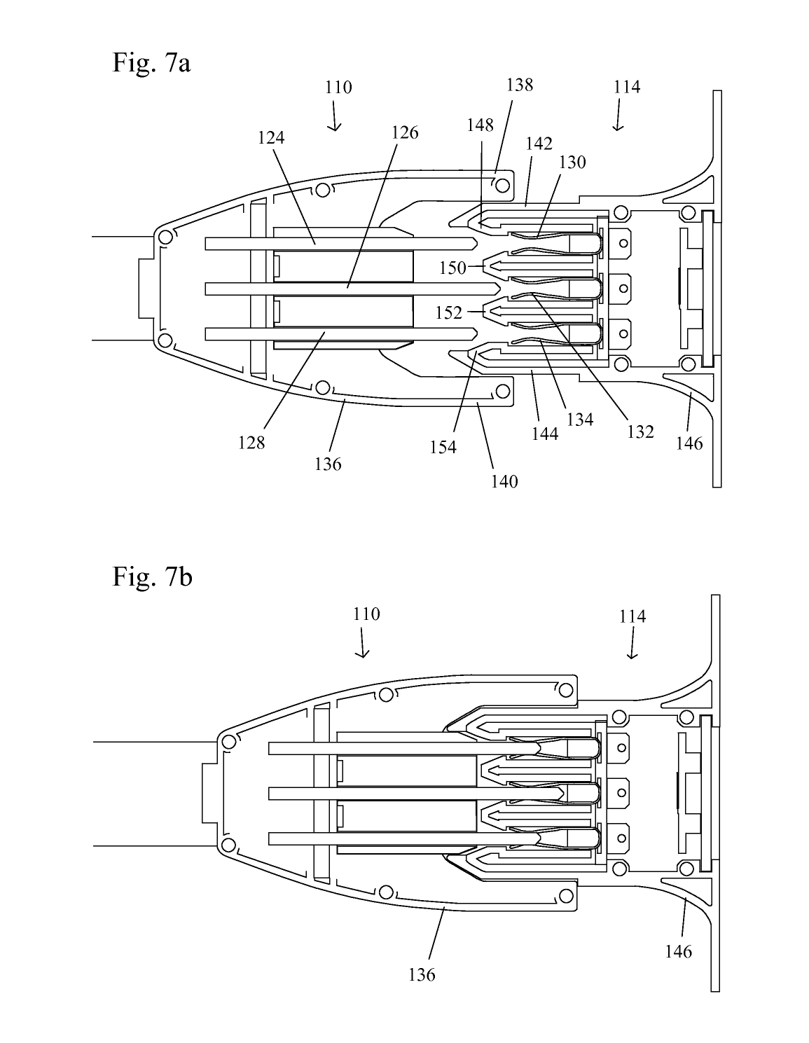

The plug is preferably attached to the portable electronic device, which may be a cart, on a rigid arm and includes electrical contacts and self-guiding features. One of many possible configurations for contacts is a vertically stacked blade-type contacts (see FIG. 7a and FIG. 7b). In AC applications, the ground contact protrudes out more than the other terminals for safety. The plug rides along the contoured surface of the housing for self-alignment of the mated contacts. The arm may be moveable in and out of the mounting bracket to accommodate various cart configurations and spacing requirements (see FIG. 5).

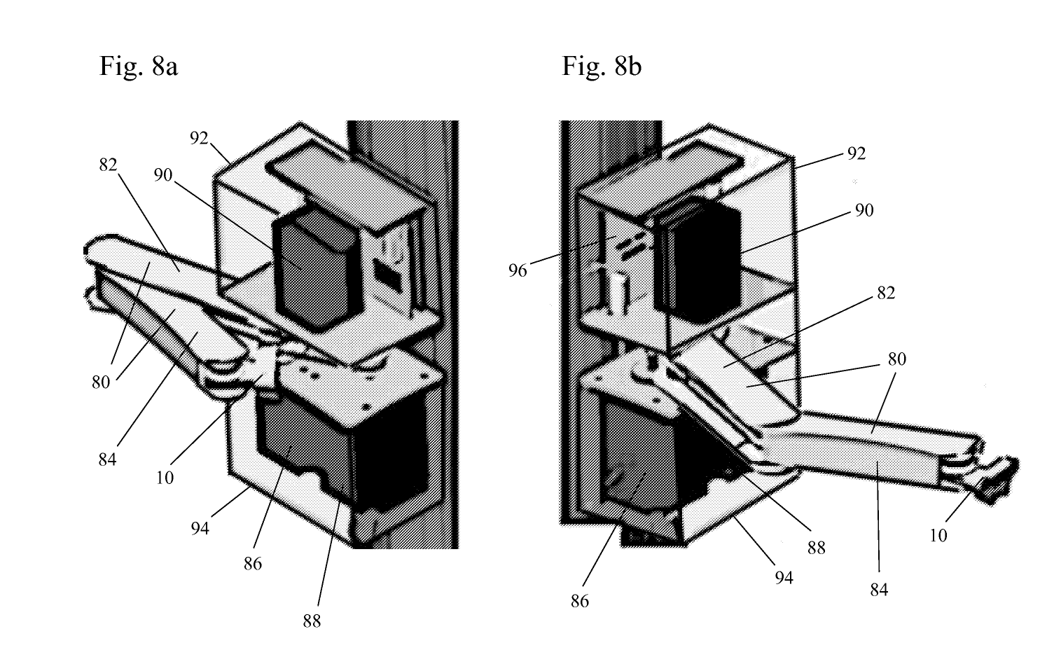

In other embodiments, the arm may be electrically driven, such as in the manner of a robotic arm (see FIG. 8a and FIG. 8b). In these embodiments, the mating plug is attached to a multi-jointed arm driven by servo or stepper motors to automatically connect with the receptacle. This is done by sensing a target, in this case the receptacle, when the cart is within range of a charging station. Target acquisition may be accomplished by employing proximity detection technology, such as infrared proximity detection, to locate the position of the receptacle. An on-board motor controller may calculate the movement needed to make a successful connection. This automation may alternatively be realized by mounting the electrically driven arm on the receptacle.

Referring first to FIG. 1, a plug 10 on an arm 12 extending from the body of the portable electronic device is engaged with the receptacle 14 mounted on and extending from a stationary surface 16. The receptacle 14 includes three parallel slots 18, 20, 22 to receive three prongs from the plug 10. In the side view of FIG. 2, the three prongs 24, 26, 28 have been inserted between the electrical contacts 30, 32, 34 in the three parallel slots of the receptacle 14. The three parallel slots of the receptacle allow the plug to be inserted at any lateral position along the receptacle and the receptacle is preferably long enough to provide space for more than one plug to be simultaneously engaged with the receptacle. FIG. 3 shows three different plugs 10 on three different arms 12 of three different portable devices simultaneously engaged with the receptacle 14. In the embodiment of FIG. 1 through FIG. 3, the charging station also includes two conventional three-prong outlet receptacles such that conventional corded two-prong or three-prong plugs may also be plugged in to the charging station. In some embodiments, the conventional three-prong outlet receptacles are GFCI outlet receptacles.

FIG. 2 also shows the internal components of the plug 10 and the receptacle 14 and a pair of preferred mating profiles of the plug 10 and receptacle 14 to promote proper engagement while minimizing shock hazard and the likelihood of damaging the electrical components of either part. The plug head 36 includes plug extensions 38, 40 that flank outer extensions 42, 44 on the base 46 of the receptacle 14. The outer extensions 42, 44 taper toward their tips to provide angled guiding surfaces to direct the plug extensions 38, 40 into a proper alignment with the outer extensions 42, 44 if the plug 10 is misaligned when initially brought toward the receptacle 14. The receptacle also includes inner extensions 48, 50, 52, 54 that form the parallel slots and house the electrical contacts 30, 32, 34. The inner extensions 48, 50, 52, 54 include tapered tips that direct the prongs 24, 26, 28 toward their proper slots and prevent accidental contact with the electrical contacts 30, 32, 34 of the receptacle 14. Although the outer extensions 42, 44 are shown as separate components from the inner extensions 48, 54, the outer extension 42 and inner extension 48 may alternatively be formed as a single component and the outer extension 44 and inner extension 54 may alternatively be formed as a single component. Although the prongs 24, 26, 28 are shown in the same plane in FIG. 2, one or more of the prongs 24, 26, 28 may be offset from the planes of the others by any amount and still engage with the receptacle 14 as long as the prongs 24, 26, 28 have the appropriate lateral spacing matching the spacing of the parallel slots of the receptacle 14. The ground prong 26 preferably protrudes out farther than and is located between the other two prongs 24, 28.

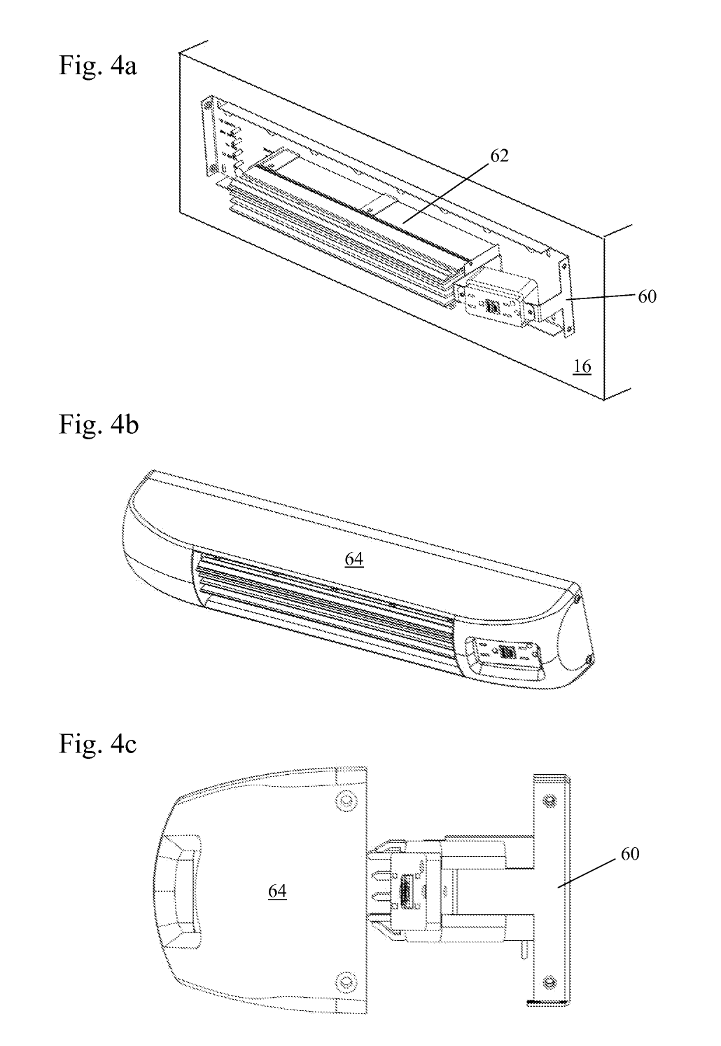

As shown in the embodiment of FIG. 4a through FIG. 4c, a bezel 64 mounts over the housing 60 and rigid base 62 and covers all other exposed surfaces where electrical hazards may be present. FIG. 4a shows a perspective view of the housing 60 and rigid base 62 without the bezel, and FIG. 4b shows a perspective view with the bezel 64 installed. FIG. 4c shows a side view of the bezel 64 fitting over the housing 60 and rigid base 62.

FIG. 5 shows a plug 10 on an extendable arm 70 that moves in and out of the mounting bracket 72 to accommodate various cart configurations and spacing requirements between the cart and the receptacle. The position of the arm is preferably set manually using a piece of hardware which may be removed to change the length of the arm and replaced once the arm is at the desired length. The arm 70 preferably telescopes into or out of the mounting bracket 72 within a predetermined range of extension to adjust the distance that the arm 70 extends from the mounting bracket 72. The arm may include a series of retractable tabs along part of the length of the arm, and the mounting bracket may include a hole to receive the retractable tab that is aligned with the hole to help maintain the arm in the current extension position. Alternatively, the mounting bracket may include a retractable tab and the arm may include a series of holes to engage the retractable tab.

In the side view of the embodiment of FIG. 6, the three prongs 124, 126, 128 have been inserted between the electrical contacts 130, 132, 134 in the three parallel slots of the receptacle 114. The three parallel slots of the receptacle 114 allow the plug 110 on the arm 112 to be inserted at any lateral position along the receptacle 114.

FIG. 7a and FIG. 7b show in greater detail the internal components of the plug 110 and the receptacle 114 and a pair of preferred mating profiles of the plug 110 and receptacle 114 to promote proper engagement while minimizing shock hazard and the likelihood of damaging the electrical components of either part. The plug head 136 includes plug extensions 138, 140 that flank outer extensions 142, 144 on the housing 146 of the receptacle 114. The outer extensions 142, 144 taper toward their tips to provide angled guiding surfaces to direct the plug extensions 138, 140 into a proper alignment with the outer extensions 142, 144 if the plug 110 is slightly misaligned when initially brought toward the receptacle 114 within a range of tolerance of the blind-mate power charging station. The receptacle also includes inner extensions 148, 150, 152, 154 that form the parallel slots and house the electrical contacts 130, 132, 134. The inner extensions 148, 150, 152, 154 include tapered tips that direct the prongs 124, 126, 128 toward their proper slots with lips that protect the ends of the electrical contacts 130, 132, 134 from damage and prevent accidental contact with the electrical contacts 130, 132, 134 of the receptacle 114. Although the prongs 124, 126, 128 are shown in the same plane in FIG. 7a and FIG. 7b, one or more of the prongs 124, 126, 128 may be offset from the planes of the others by any amount and still engage with the receptacle 114 as long as the prongs 124, 126, 128 have the appropriate lateral spacing matching the spacing of the parallel slots of the receptacle 114. The ground prong 126 preferably protrudes out farther than and is located between the other two prongs 124, 128.

In some embodiments, the power charging station is located on a wall or other stationary surface at a predetermined height above the floor and the arm of the portable electronic device cart holds the plug at a height above the floor within a predetermined tolerance range of the receptacle of the power charging station such that mating the plug of the portable electronic device cart with the receptacle of the power charging station requires only that the electronic device cart be rolled up to the appropriate distance from the wall for the plug to engage the receptacle without any further human intervention being required.

FIG. 8a and FIG. 8b show an alternate embodiment, where an electrically-driven robotic arm 80 with a plug 10 on the end of the arm 80 provides automated mating of the plug 10 to a receptacle. In a preferred embodiment, the robotic arm 80 is maintained in a retracted position, such as the position shown in FIG. 8a, when the plug 10 is not engaged with a receptacle. This minimizes the risk of the robotic arm 80 or plug 10 causing damage or being damaged when the portable electronic device is being moved or transported. The robotic arm 80 then extends, such as to the position shown in FIG. 8b, to automatically engage the receptacle of a charging station.

The multi-jointed robotic arm 80 includes a primary joint 82 and a secondary joint 84 and is driven by servo or stepper motors 86, 88, 90 to automatically connect with a charging station receptacle. In the embodiment show in FIG. 8a and FIG. 8b, the motors 86, 88, 90 include a primary motor 86, a secondary motor 88, and a connector motor 90. The motors 86, 88, 90 are protected by housings 92, 94. When the portable electronic device is within range of a charging station, the receptacle is preferably automatically sensed by employing proximity detection technology, such as infrared proximity detection, to locate the position of the receptacle. An on-board motor controller 96 may calculate the movement needed to make a successful connection. The servo or stepper motors 82, 84 then provide the output to carry out the movement of the robotic arm 80 to engage the plug 10 with the receptacle.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A blind-mate power charging station comprising:
a receptacle comprising:
a receptacle housing comprising a pair of outer extensions, each outer extension tapering toward an outer extension tip;
an inner housing held within the receptacle housing and comprising a plurality of inner extensions forming a plurality of parallel slots between pairs of the plurality of inner extensions;
a plurality of electrical contacts, each electrical contact being held in one of the plurality of parallel slots by a pair of the plurality of inner extensions;
a base receiving the receptacle and mounting the receptacle to a stationary surface; and
electrical circuitry coupling the plurality of electrical contacts to an electricity source;
wherein the receptacle is shaped to receive a plug comprising a plug head and at least two prongs, each prong engaging one of the plurality of electrical contacts such that the receptacle provides electricity to the plug.

2. The blind-mate power charging station of claim 1 further comprising a bezel mounted around the receptacle to cover otherwise exposed receptacle surfaces and reduce electrical hazards.

3. The blind-mate power charging station of claim 1, wherein the parallel slots are sized to receive and supply electricity to a plurality of the plugs simultaneously.

4. The blind-mate power charging station of claim 1 further comprising ground fault circuit interrupter circuitry.

5. The blind-mate power charging station of claim 1, wherein the outer extensions of the receptacle housing taper to provide tapered surfaces to direct the prongs into alignment with the parallel slots by contacting one of a pair of plug extensions of the plug head if the prongs are misaligned with the parallel slots.

6. A method of docking a portable electronic device to a blind-mate power charging station, the method comprising the steps of:
a) aligning a plug on an arm of the portable electronic device to a receptacle of the blind-mate power charging station, wherein the receptacle comprises:
a receptacle housing comprising a pair of outer extensions, each outer extension tapering toward an outer extension tip;
an inner housing held within the receptacle housing and comprising a plurality of inner extensions forming a plurality of parallel slots between pairs of the plurality of inner extensions;
a plurality of electrical contacts, each electrical contact being held in one of the plurality of parallel slots by a pair of the plurality of inner extensions; and
wherein the plug comprises:
a plug head; and
at least two prongs extending from the plug head; and
b) moving the arm such that each of the at least two prongs is inserted into one of the plurality of parallel slots to contact one of the plurality of electrical contacts, thereby docking the portable electronic device to the blind-mate power charging station.

7. The method of claim 6, wherein step b) comprises a user rolling the portable electronic device toward the blind-mate power charging station until the plug engages the receptacle.

8. The method of claim 6 further comprising the step of sensing a location of the receptacle.

9. The method of claim 8, wherein the step of sensing occurs automatically by proximity detection technology.

10. The method of claim 6, wherein step a) and step b) are performed automatically without human intervention.

11. The method of claim 6, wherein the arm is a robotic arm and step a) comprises the sub-step of directing a motor to adjust a position of the robotic arm to align the plug with the receptacle.

12. The method of claim 6, wherein the arm is an extendable arm and step b) comprises the sub-step of directing a motor to extend the extendable arm from a mounting bracket toward the receptacle.
